(19) United States
(12) Patent Application Publication
(10) Pub. No.: US 2005/0075940 A1
(43) Pub. Date: Apr. 7, 2005

(54) Remote shopping system with integrated product specific advertising

(76) Inventor: Lawrence J. DeAngelis, Oceanside, CA (US)

Correspondence Address: RICHARD C. HIMELHOCH, 311 S. WACKER DRIVE, 53RD FLOOR, CHICAGO, IL, 60606-6622, US

(21) Appl. No.: 10/679,791

(22) Filed: Oct. 6, 2003

(51) Int. Cl. G06F 17/60

(52) U.S. Cl. 705/26

(57) ABSTRACT

A method and system for remotely building a shopping list for remote shopping and ordering merchandise electronically. A shopping list can be built any time, anywhere by scanning, speaking, or keying-in barcode numbers such as UPC codes into a data collection device that can be an intricate part of the terminal or interfaced to the terminal The terminal is used for ordering merchandise through a direct distance dial or wireless telephone network, that could utilize or connect to the Internet, to connect to a shopper assistance portal that maintains information relating to a plurality of merchants and a plurality of product offered by the plurality of merchants. The merchandise is identified by barcode numbers in the form of individual digital merchandise codes. The geographical location of order placement can be configured by the user to select only merchants that service the location. When a shopper selects a merchant, a link is executed to the merchant's e-commerce server where the shopper could proceed with the order through the order receiving system that the merchant has incorporated into their e-commerce system. A shopper may purchase all, one, or selected products. Purchases and return transactions are preferably conducted between the shopper and the individual merchant. The targeted product specific advertising program searches the shopper's list for specific products that a shopper in the merchant's service area is planning to buy. Ads are displayed on the terminal relevant to items that match specific barcode numbers. If the shopper clicks through on the ad, the shopper will enter the merchant's site through a special URL along with their active shopping list in an attached data packet.

### TECHNICAL FIELD

The present invention is generally related to a remote shopping system and method, and more particularly, to a system and method for electronically shopping and ordering products identified by digital barcode numbers from a plurality of merchants using a terminal device.

The present invention is also generally related to a targeted product specific advertising program, and more particularly, to a system and method that analyzes an electronic shopping list of a potential purchaser and transmits specific advertising to the potential purchaser responsive to the products identified by digital barcode numbers in the shopping list.

### BACKGROUND

In part, the present invention is an enhancement of the system shown in U.S. Pat. No. 4,654,482 (“the '482 patent”), which issued to the present inventor on Mar. 31, 1987. The '482 patent described a system utilizing a terminal for ordering merchandise from one of a plurality of merchants over a direct distance dial telephone network. Products were identified by the user by scanning barcodes using a barcode reader, which communicated with the terminal. In this regard, the '482 Patent was limited to building a shopping list of one or more bar-coded products that could be shopped at a plurality of merchants. In the almost twenty years since the system described in the '482 patent was conceived, technology has increased exceedingly. The Internet has matured, Wireless technology is everywhere, e-commerce has become a household word, voice recognition is a reality, Radio Frequency Identification tags (RFID) have been invented, and microprocessors have become increasingly smaller, faster, and cheaper. Meanwhile, the population, the amount of pollution, the price of fuel, and the amount of road traffic has increased dramatically, prompting consumers to consider home shopping as a time and money saving alternative.

Presently a shopping list can be built piecemeal, any time and anywhere, by scanning, speaking, or keying-in barcode numbers of desired products into all kinds of terminals. These range from personal computers, to cell-phones and numerous other handheld and standalone terminals and devices. Merchants worldwide, encouraged by the popularity of the Internet and Wireless technology, are setting up Web enabled e-commerce shops in ever increasing numbers.

### SUMMARY OF THE INVENTION

Unlike prior systems, the present invention is designed to accumulate digital barcode numbers into a shopping list, online or offline, and enhance existing and future e-commerce merchants by acting as a Portal between the shoppers and the e-commerce merchant. Additionally, the system provides a targeted product specific advertising program.

Preferably, shoppers would register to become a user of the system. Upon registration, the shopper can download the application software or request the software through the mail. The shopper can interact with the system through an Internet connection or through a direct distance dial telephone network utilizing a modem. Merchants could become members and specify the area(s) (i.e. the geographical location) that they want to service and provide a list of barcode numbers of products they present for sale, and appropriate URL addresses of the merchant's website to direct shoppers to.

In one embodiment of the invention, a method for remotely shopping and ordering merchandise electronically using a terminal device, such as a personal computer, is provided. The method comprises the step of electronically building a list of digital barcodes of products and electronically connecting a user (i.e., a shopper or potential purchaser) to a shopper assistance portal using a terminal device. Preferably, the connection is made via the Internet; however, a direct dial modem connection can also be utilized. The shopper assistance portal maintains information relating to a plurality of merchants and a plurality of products offered by the plurality of merchants. The method further includes downloading the information relating to a plurality of merchants and a plurality of products offered by the plurality of merchants to the terminal device from the shopper assistance portal and saving the information in a memory associated with the terminal device. The user can then review the information off-line and determine which of the plurality of products the user desires to purchase. In combination with such review, the user performs the next step of creating a potential order in the form of an active list of selected products from the information relating to a plurality of merchants and a plurality of products offered by the plurality of merchants saved in the memory. Moreover, this list can be saved on the terminal for later (i.e., repeated) use.

The method would then include the steps of uploading the active list of selected products to the shopper assistance portal from the terminal device and, electronically providing at least a first portion of the active list of selected products to at least a first merchant of the plurality of merchants for fulfilling at least a first portion of the order. The first merchant may also be responsible for fulfilling the entire order. Alternatively, the method may include electronically providing a second portion of the active list of selected products to a second merchant of the plurality of merchants for fulfilling a second portion of the order. Moreover, one or more additional merchants can be responsible for fulfilling any remaining portions of the order. The merchants may be selected based on the geographical location that the shopper has indicated (i.e., merchants that serviced the location would be selected).

The method can further include displaying the plurality of products on the shopper's terminal along with a description of the products and optionally pictures of the products. Using the terminal device, a user can perform the step of electronically selecting a first product offered by a first manufacture of the plurality of products displayed and electronically request a comparison of other products with the first product. The shopper assistance portal can be configured to then display similar products offered by other manufacturers to the selected first product. Alternatively, the portal can display similar models to the first product being offered by the first manufacture.

The user can electronically submit a request for a search of a product to the shopper assistance portal. The shopper assistance portal will then display products responsive to the requested search.

The method can further comprise the steps of electronically providing the shopper assistance portal with a location of placement of the order (i.e., the shopper's postal code), this information may be transmitted when the shopper logs onto the shopper assistance portal. Additionally the shopper may select alternative locations. The shopper assistance portal can be configured to only display merchants offering selected products in the shopping list that service the location. The list of merchants can be sorted in a number of ways, such as alphabetically, or as to the number of products, each listed merchant has of the shopper's order. The shopper can select alternative locations when they are connected to the shopper assistance portal.

The method can further include electronically completing the purchase of a selected product from a listed merchant. This can be done by connecting the user directly to a site maintained by the merchant(s) fulfilling the order.

In another embodiment of the invention, a method for electronically providing product specific advertising to a prospective purchaser is provided. The method comprises the steps of electronically receiving an active list of selected bar-coded products by a shopper assistance portal from a terminal device and, electronically transmitting to the terminal device a first advertisement from a merchant associated with the shopper assistance portal responsive to at least a first product from the active list of selected products. Additional advertisements responsive to other products on the active list from the same merchant or different merchants can also be transmitted to the terminal device.

The shopper assistance portal can electronically receive a list of products and corresponding advertisements from the merchant. The portal then compares the products provided by the prospective purchaser (i.e., the active list) with the list of products received from the merchant and can send relevant advertisements to the prospective purchaser. Moreover, the shopper assistance portal can determine the location of the potential purchaser and transmit an advertisement from a merchant that services that location.

The method further includes searching the active list by the shopper assistance portal for products that match criteria set forth by a first merchant that services a location of a purchaser using the terminal device. The shopper assistance portal then selects an advertisement from the first merchant for transmission to the terminal device. This can be done for a second merchant (or a plurality of merchants) that services the location of the purchaser using that merchant's criteria.

If the purchaser does not desire to receive advertisements, the purchaser can select to turn off the view advertisement option. In this regard, the method then includes receiving a transmission from the terminal device disabling the shopper assistance portal from performing the step of electronically transmitting to the terminal device any advertisements from a merchant by the shopper assistance portal responsive to the active list of selected products.

The method can be further used to facilitate the purchase of a product. This may include providing a link to a website maintained by the merchant through the first advertisement. The merchant can then electronically receive an order for a product identified in any of the advertisements provided to the terminal device and possibly other products in the shopper's active list.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of operation of a remote shopping portal in accordance with an aspect of the present invention;

FIG. 2 is a further block diagram of operation of the remote shopping portal of FIG. 1;

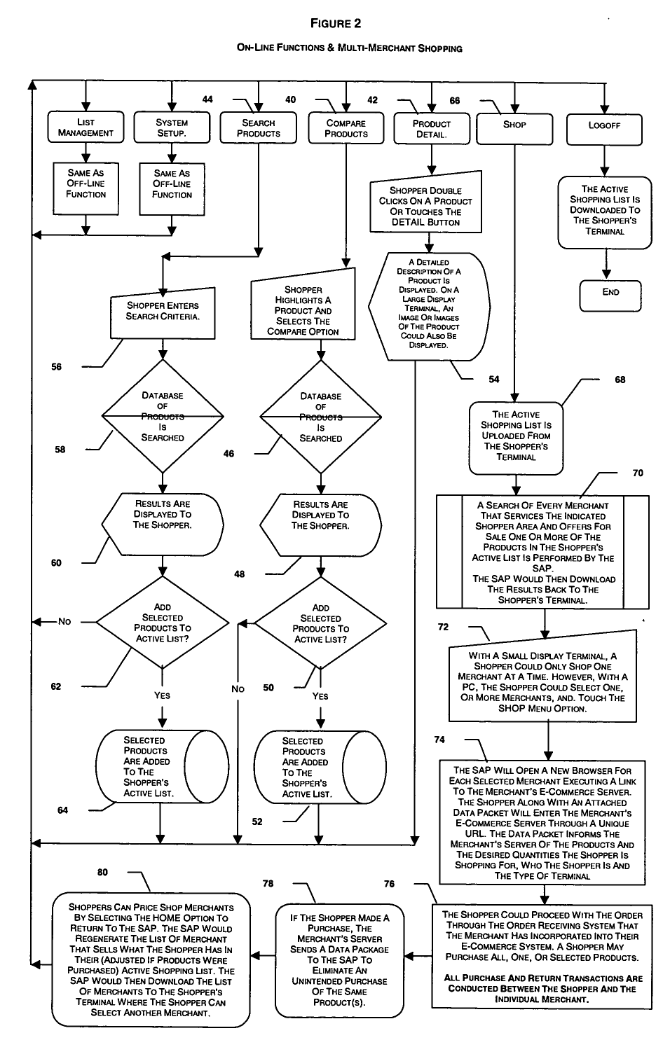

FIG. 3 is a block diagram of a product specific advertising system in accordance with an aspect of the present invention;

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

This invention is comprised of two distinct components; a computer aided shopping system, and a targeted product specific advertising program.

Computer Aided Shopping System:

1. List Building:

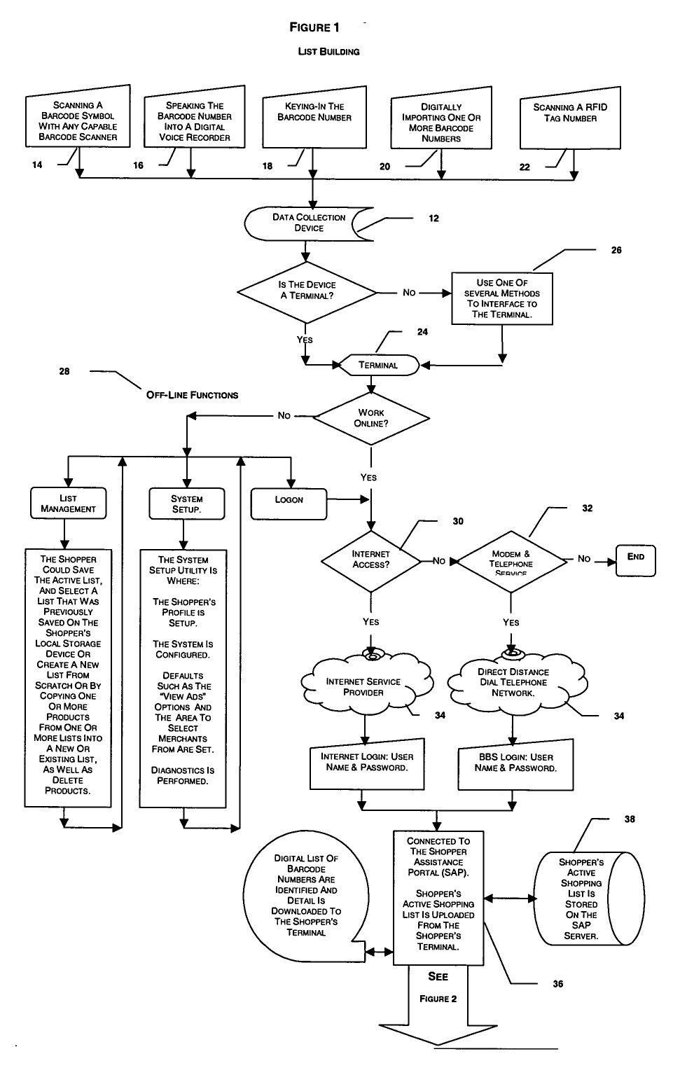

Referring to FIG. 1, a block diagram for a computer aided shopping system is illustrated. Initially, a list of products (i.e., goods for purchase by a shopper) is created by means of digitally collecting barcode numbers such as UPC codes into a data collection device 12. The barcodes (i.e., data) can be collected by; scanning a barcode symbol with any capable barcode scanner 14, and/or by speaking the barcode number into a digital recording device 16. Other alternative collection means could include keying-in the barcode number 18, and/or digitally importing one or more barcode numbers 20, and/or scanning a RFID tag number 22 into a data collection device 12. The data collection device 12 can be an integral part of the terminal 24 or a separate device 12 that is connected 26 to a terminal in a variety of ways. For example, the separate device could be hard-wired, or have a wireless connection, a serial port connection, a parallel port connection, a universal serial bus (USB) connection, or an infrared interface connection to the terminal 24.

The terminal 24 is used for ordering merchandise through a direct distance dial or wireless telephone network, to connect to a shopper assistance portal (SAP). The direct distance dial or wireless telephone network could utilize or connect to the Internet. The SAP acts as a Portal between the shopper and a plurality of merchants. Each merchant has an order receiving apparatus that can be accessed through the Internet, or the direct distance dial telephone network. The merchandise is identified by barcode or RFID tag numbers in the form of individual digital merchandise codes.

When shoppers utilize the shopping system, they can work offline (as generally illustrated at 28) using a database of barcode numbers and associated descriptions that can be created automatically and saved to their local storage device every time the shopper uses the system online. If the shopper has Internet access 30 they can login to the SAP using their browser. However, if the shopper does not have an Internet Service Provider, they can connect to the system's SAP using a modem and the direct distance dial telephone network 32. Once login 34 is complete, the SAP could automatically upload 36 the shopper's digital list of barcode numbers from the shopper's terminal (i.e., an “active list” of products created by the shopper from the entire list of bar coded items available) and then return a list in alphabetical order of the descriptions of all the products in the active list to the shopper's terminal. A copy of the “active list” is retained on the SAP 38 until the shopper logs-off.

The SAP may interact with each shopper differentially depending on the kind of terminal the particular shopper is using. On a terminal with as little as an eighty-character display such as a cell-phone or a dedicated device, the list could be arranged into columns. The columns could include: a Quantity field that can be edited by the shopper, and a Basic Description field. Whereas on a large display terminal such as a personal computer, the UPC/EAN barcode Number, the Manufacture, and the Manufacture's Suggested Retail Price fields could also be displayed.

If a shopper entered or scanned the same barcode number more than one time, the count will be reflected in the Quantity field. If the shopper enters a zero (0) into the Quantity field, a product can be removed (deleted) from the active list. Products with a zero value in the Quantity field will be excluded from the Shopping function.

The shopper could save the active list, and select a list that was previously saved on the shopper's local storage device or create a new list from scratch or by copying one or more products from one or more lists into a new or existing list.

Certain functionality is available to the shopper when logged onto the SAP. The shopper could highlight a product and select a COMPARE PRODUCTS menu option 40 to compare similar products offered by different manufacturers as well as similar models offered by the same manufacture. The database of products is searched 46 and the results are displayed to the shopper 48. One or more of the products displayed can be added to the shopper's active list 50 and 52.

By double clicking on a product or touching the PRODUCTS DETAIL option 42, the shopper could get a detailed description of a product 54. On a large display terminal, an image, or images of the product could also be displayed 54.

The shopper could also search for products 44. The shopper could enter a search criteria 56. The SAP would then search a database of products 58 and display the results to the shopper 60. Similar to the COMPARE PRODUCTS option, select products can be added to the shopper's active list 62 and 64.

2. Multi-Merchant Shopping:

To determine which merchants the shopper could shop with, the shopper could select a SHOP menu option 66 that would execute a command that would upload the active shopping list from the shopper's terminal to the SAP 68. Upon receipt, the SAP would do a search of every merchant that services the designated shopper area and offers for sale one or more of the products in the shopper's active list 70. The SAP would then download the results back to the shopper's terminal 70.

Some merchants sell several or all of the product in the shopper's list while others may sell only a few or perhaps only one product. The arrangement in which the merchants are presented to the shopper could be sorted in descending order, depending on the number of products each merchant offers for sale. If the shopper were shopping for only one product, the list of merchants could be in alphabetical order according to the merchant's name. Merchants could be presented to the shopper along with the count of products that each merchant offers.

To shop a merchant, the shopper would select one of the merchants and then select the SHOP menu option. This requests the SAP to execute a link to the merchant's e-commerce website 74. If the shopper has a small display terminal, the shopper could only shop one merchant at a time 72. However, with a PC or a larger associated terminal, the shopper could select one or more merchants facilitating side-by-side comparison 72. The system can be configured so that touching the SHOP menu option instructs the SAP to open a new browser for each selected merchant to execute a link to the merchant's e-commerce server(s) 74. The shopper along with an attached data packet will enter the merchant's e-commerce server through a unique URL 74. The data packet informs the merchant's server of the products and the desired quantities the shopper is shopping for, who the shopper is and the type of terminal used by the shopper 74. The point of entry will bypass the normal home page on the merchant's site, since the shopper already has the merchant's products selected. The merchant may ask the shopper whether the shopper is interested in companion products (for example, if the shopper is buying cake mix, the merchant may inquire whether the shopper needs frosting) but the shopper could always go directly to a checkout section on the site.

If the shopper is satisfied with the merchant's price, as well as the terms and conditions of the purchase, the shopper could proceed with the order through the order receiving system that the merchant has incorporated into their e-commerce system 76. A shopper may purchase all, one, or selected products. All purchase and return transactions are preferably conducted between the shopper and the individual merchant.

If the shopper made a purchase, the merchant's server will send a data package to the SAP to eliminate an unintended purchase of the same product(s) 78. The data package could contain the merchant's ID, the shopper's ID, the barcode number(s) of the product(s), and quantities purchased 78. The SAP would adjust the quantity field in the shopper's active list to match the data package.

Shoppers can price shop merchants simply by selecting a HOME option to return to the SAP 80. The SAP would regenerate the list of merchant that sells what the shopper has in their active shopping list (this list may be adjusted if products were purchased). The SAP would then download the list of merchants to the shopper's terminal where the shopper can select another merchant(s).

It should be understood that in addition to products, the bar coded items can be services offered by a one or more merchants or service providers.

Targeted Product Specific Advertising Program:

Internet advertising has always been a hit and miss proposition. The targeted product specific advertising program disclosed is different because it searches the shopper's list for specific products that a shopper is planning to buy. For example, suppose a merchant wants to target shoppers that have a particular brand or brands of bathroom tissue in their shopping list. The merchant could have the system display an ad to the shopper offering the shopper the brand of bathroom tissue that the shopper has in their list or a house brand for a very low price or even free with an order. If the shopper clicks through on the ad, the shopper will enter the merchant's site through a special URL along with their active shopping list in an attached data packet. The advantage to the merchant is an opportunity to service a shopper and possibly receiving an additional order from a shopper.

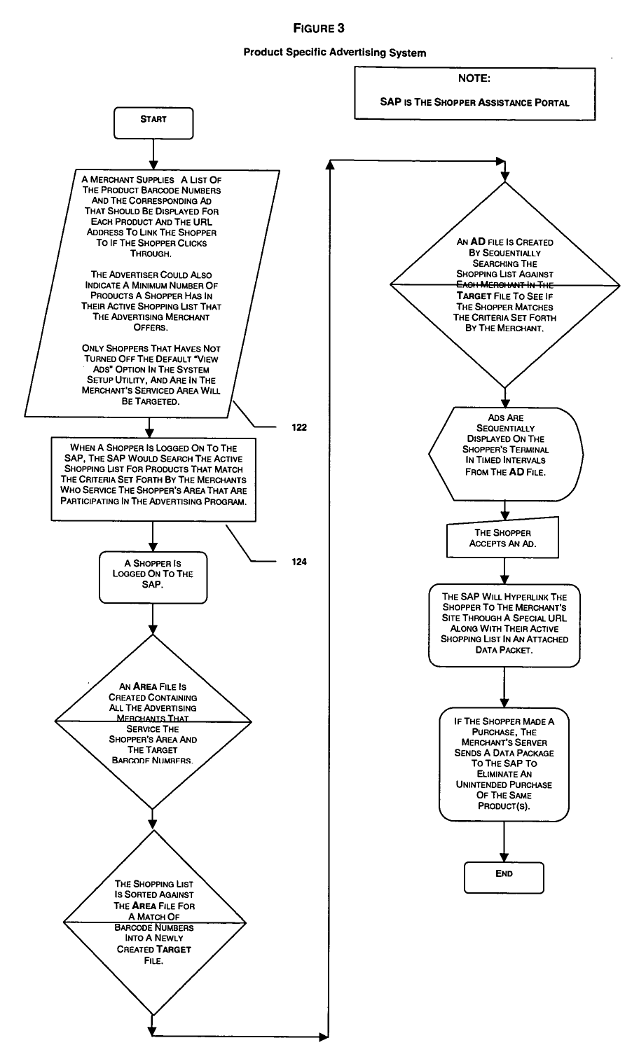

As illustrated in FIG. 3, a merchant utilizes the targeted product specific advertising program by supplying a list of the product barcode numbers and the corresponding ad that should be displayed for each product and the URL address to link the shopper to if the shopper clicks through 122. The advertiser could also indicate a minimum number of products a shopper has in their active shopping list that the advertising merchant offers 122. Typically, only merchants that service in the area that the shopper selected will be targeted 122. When a shopper is logged on to the SAP, the SAP would search the active shopping list for products that match the criteria set forth by the merchants who service the shopper's area that are participating in the advertising program 124. Ads are presented to the shoppers only if the shopper has not turned the default “View Ads” option off in the system setup utility.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method for remotely shopping and ordering merchandise identified by digital barcode numbers electronically using a terminal device comprising the steps of:
electronically collecting a plurality of barcode numbers with a data collection device communicatively coupled to the terminal;
electronically connecting to a shopper assistance portal using a terminal device, the shopper assistance portal maintaining information relating to a plurality of merchants and a plurality of product offered by the plurality of merchants;
downloading the information relating to a plurality of merchants and a plurality of products offered by the plurality of merchants to the terminal device from the shopper assistance portal and saving the information in a memory associated with the terminal device;
creating a potential order in the form of an active list of selected products from the information relating to a plurality of merchants and a plurality of products offered by the plurality of merchants saved in the memory;
uploading the active list of selected products to the shopper assistance portal from the terminal device; and,
electronically providing at least a first portion of the active list of selected products to at least a first merchant of the plurality of merchants for placing at least a first portion of the order.

2. The method of claim 1 wherein the step of electronically collecting a plurality of barcode numbers with a data collection device communicatively coupled to the terminal comprises:
one of scanning a barcode symbol with a barcode scanner, speaking a barcode number into a digital voice recorder, keying-in a barcode number, digitally importing a barcode number, and scanning a RFID tag number with an RFID scanner.

3. The method of claim 2 wherein the data collection device can be activated a plurality of times to build the active list.

4. The method of claim 1 further comprising the step of:
electronically providing a second portion of the active list of selected products to a second merchant of the plurality of merchants for placing a second portion of the order.

5. The method of claim 1 further comprising the steps of:
displaying the plurality of products on the terminal device;
electronically selecting a first product offered by a first manufacture of the plurality of products displayed;
electronically requesting a comparison of other products with the first product; and,
displaying similar products offered by other manufacturers to the first product.

6. The method of claim 1 further comprising the steps of:
displaying a plurality of products on the terminal device;
electronically selecting a first product offered by a first manufacture of the plurality of products displayed;
electronically requesting a comparison of other products with the first product; and,
displaying similar products to the first product being offered by the first manufacture.

7. The method of claim 1 further comprising the steps of:
selecting a product displayed on the terminal device; and,
providing a detailed description of the selected product from the shopper assistance portal to the terminal device.

8. The method of claim 1 further comprising the steps of:
electronically submitting a request for a search of a product to the shopper assistance portal; and,
displaying products by the shopper assistance portal responsive to the requested search to the terminal device.

9. The method of claim 1 wherein the terminal device is a stand-alone device and wherein the step of electronically connecting to a shopper assistance portal using a terminal device comprises using the stand-alone device to connect to the shopper assistance portal over the Internet.

10. The method of claim 1 wherein the terminal device is a personal computer and wherein the step of electronically connecting to a shopper assistance portal using a terminal device comprises using the personal computer to connect to the shopper assistance portal over the Internet.

11. The method of claim 1 wherein the terminal device is a personal computer and wherein the step of electronically connecting to a shopper assistance portal using a terminal device comprises using the personal computer to connect to the shopper assistance portal over the direct distance dial telephone network.

12. The method of claim 1 wherein the terminal device is a programmable web enabled cell phone and wherein the step of electronically connecting to a shopper assistance portal using a terminal device comprises using the programmable web enabled cell phone to connect to the shopper assistance portal over the Internet.

13. The method of claim 1 wherein the terminal device is a stand-alone device and wherein the step of electronically connecting to a shopper assistance portal using a terminal device comprises using the stand-alone device to connect to the shopper assistance portal over a direct distance dial telephone network.

14. The method of claim 1 further comprising the steps of:
providing the shopper assistance portal with a geographical location of placement of the order; and,
displaying a list of merchants offering selected products in the potential order that service the location.

15. The method of claim 14 wherein the user of the terminal device provides the shopper assistance portal with an alternative geographical location.

16. The method of claim 14 further comprising the step of:
sorting the list of merchants as to the number of products each listed merchant has of the potential order.

17. The method of claim 14 further comprising the steps of:
electronically completing purchase of a selected product from a listed merchant.

18. The method of claim 1 further comprising the step of:
saving the active list on the terminal device.

19. A method for electronically providing product specific advertising to a prospective purchaser comprising the steps of:
electronically receiving an active list of selected products by a shopper assistance portal from a terminal device; and,
electronically transmitting to the terminal device a first advertisement from a merchant associated with the shopper assistance portal responsive to at least a first product from the active list of selected products.

20. The method of claim 19 further comprising the step of:
electronically transmitting to the terminal device a second advertisement from the merchant associated with the shopper assistance portal responsive to a second product from the active list of selected products.

21. The method of claim 19 further comprising the steps of:
electronically receiving a list of products from the merchant by the shopper assistance portal;
electronically receiving corresponding advertisements for the products in the list of products from the merchant by the shopper assistance portal; and,
and electronically receiving corresponding URL addresses to the corresponding advertisements by the merchant to link prospective purchasers to the corresponding advertisements by the shopper assistance portal.

22. The method of claim 19 wherein the step of electronically transmitting to the terminal device a first advertisement from a merchant by the shopper assistance portal responsive to at least a first product from the active list of selected products comprises transmitting the first advertisement from a merchant that services the location selected by the purchaser using the terminal device.

23. The method of claim 19 further comprising the step of:
searching the active list by the shopper assistance portal for products that match criteria set forth by a first merchant that services the location selected by the purchaser using the terminal device.

24. The method of claim 23 further comprising the step of:
selecting an advertisement from the first merchant for transmission to the terminal device.

25. The method of claim 23 further comprising the step of:
searching the active list by the shopper assistance portal for products that match criteria set forth by a second merchant that services a location of the purchaser using the terminal device.

26. The method of claim 25 further comprising the step of:
selecting an advertisement from the second merchant for transmission to the terminal device.

27. The method of claim 19 further comprising the step of:
receiving a transmission from the terminal device disabling the shopper assistance portal from performing the step of electronically transmitting to the terminal device at least a first advertisement from a merchant by the shopper assistance portal responsive to at least a first product from the active list of selected products.

28. The method of claim 19 further comprising the step of:
providing a link to a website maintained by the merchant through the first advertisement.

29. The method of claim 19 further comprising the step of:
electronically receiving an order for a product identified in the first advertisement from the terminal device.

30. The method of claim 26 further comprising the step of:
electronically receiving an order for a product identified in the second advertisement from the terminal device.
